(19) United States
(12) Patent Application Publication
(10) Pub. No.: US 2024/0015859 A1
(43) Pub. Date: Jan. 11, 2024

(54) COOKING DEVICE

(71) Applicant: SAMSUNG ELECTRONICS CO., LTD., Suwon-si (KR)

(72) Inventors: Geunyong PARK, Suwon-si (KR); Keunseuk OH, Suwon-si (KR); Youseop LEE, Suwon-si (KR); Sangjin JEONG, Suwon-si (KR); Pungyeun CHO, Suwon-si (KR)

(73) Assignee: SAMSUNG ELECTRONICS CO., LTD., Suwon-si (KR)

(21) Appl. No.: 18/372,837

(22) Filed: Sep. 26, 2023

Related U.S. Application Data
(63) Continuation of application No. PCT/KR2022/004162, filed on Mar. 24, 2022.

(30) Foreign Application Priority Data
Apr. 5, 2021 (KR) 10-2021-0043944

(51) Int. Cl. H05B 6/64

(52) U.S. Cl. CPC H05B 6/6414; H05B 6/6435; H05B 6/6408; H05B 6/6429

(57) ABSTRACT

A cooking device including a main body forming a cooking chamber and including a front plate having at least one first hole; a hood coupled to a lower portion of the main body; a fan and a door to open and close the cooking chamber, and including a rear panel having at least one second hole. The main body, the hood, the fan, and the door are configured so that, with the cooking chamber being closed by the door, the fan is operable to draw in air through the hood, and the air drawn in by the fan passes through the at least one first hole and then through the at least one second hole to an inside of the door.

### BACKGROUND

### 1. Field

The present disclosure relates to a cooking device, and more particularly, to a cooking device with a hood.

### 2. Description of Related Art

A cooking device is an apparatus for heating and cooking an object to be cooked, such as food, and may provide multiple functions related to cooking, such as heating, defrosting, drying, and sterilizing the object to be cooked. Such a cooking device may include, for example, an oven, such as a gas oven or an electric oven, a microwave heating device (hereinafter referred to as a microwave), a gas range, an electric range, an over-the-range (OTR), a gas grill, or an electric grill.

Specifically, an OTR is a microwave oven that incorporates a hood function to provide ventilation in a kitchen, and is installed on a wall to minimize an installation space and also to enable food to be cooked more conveniently and efficiently. The OTR may typically be installed above a cooking appliance, such as a gas stove or a cooktop installed in a kitchen sink.

Accordingly, the OTR may be equipped with an air discharge device provided to allow drawn smoke to be discharged after filtration.

### SUMMARY

According to an embodiment of the disclosure, a cooking device may include a main body forming a cooking chamber, the main body including a front plate having at least one first hole; a hood coupled to a lower portion of the main body; a fan; and a door to open and close the cooking chamber, and including a rear panel having at least one second hole, wherein the main body, the hood, the fan, and the door are configured so that, with the cooking chamber being closed by the door, the fan is operable to draw in air through the hood, and the air drawn in by the fan passes through the at least one first hole and then through the at least one second hole to an inside of the door.

According to an embodiment of the disclosure, the at least one first hole includes a plurality of first holes, and the at least one second hole includes a plurality of second holes.

According to an embodiment of the disclosure, the door may further include an upper panel provided with at least one an air discharge device including a through hole to discharge the air in the inside of the door to an outside of the cooking device.

According to an embodiment of the disclosure, the air discharge device may further include a cover portion covering a portion of the through hole, and the cover portion may include a gap between the cover portion and the upper panel to allow the air in the inside the door to be discharged to the outside of the cooking device through the through hole.

According to an embodiment of the disclosure, the cover portion may be configured to extend from a first section around the through hole, and to form the gap between the cover portion and a second section around the through hole.

According to an embodiment of the disclosure, the second section may be closer to the main body than the first section.

According to an embodiment of the disclosure, the at least one air discharge device may include a plurality of air discharge devices, and the plurality of air discharge devices may be arranged along a front direction of the door.

According to an embodiment of the disclosure, the main body may be positionable in a storage space of a cabinet, and, when the main body is positioned in the storage space of the cabinet, the door may protrude forward from the cabinet.

According to an embodiment of the disclosure, the main body may further include an outer case and an inner case accommodated in the outer case and forming the cooking chamber, and the inner case may include the front plate.

According to an embodiment of the disclosure, an opening may be in the front plate to, with the cooking chamber being closed by the door, allow air inside the main body to be discharged between the rear panel of the door and the front plate.

According to an embodiment of the disclosure, the opening may be provided on a side adjacent to the fan.

According to an embodiment of the disclosure, a cooking device may include a main body forming a cooking chamber, a hood coupled to a lower portion of the main body, a fan, a door configured to open and close the cooking chamber, and a control panel including one or more manipulation buttons and mounted on a front surface of the main body so that an inside of the control panel communicates with an inside of the main body, wherein the main body, the hood, the fan, the door, and the control panel may be configured to that, with the cooking chamber being closed by the door, the fan is operable to draw in air through the hood, and so that the air drawn in by the fan is introduced into the inside of the main body and thereafter to the inside of the control panel and is then discharged to the outside of the cooking device through an upper portion of the control panel.

According to an embodiment of the disclosure, the main body may further include a front plate having a first hole, and the control panel may further include a rear surface panel having a second hole, wherein the first hole and the second hole are configured so that the air introduced into the inside of the main body passes through the first hole and then through the second hole to be introduced to the inside of the control panel.

According to an embodiment of the disclosure, the control panel may further include an upper surface panel having an air discharge device including a through hole to discharge the air introduced to the inside the control panel to the outside of the cooking device.

According to an embodiment of the disclosure, an opening may be provided in the front plate to, with the cooking chamber being closed by the door, allow air inside the control panel to be discharged between the rear surface panel of the control panel and the front plate.

According to an embodiment of the disclosure, a cooking device may be installed in a cabinet forming a storage space, and the cooking device may include a main body including a front plate installed in the storage space to protrude from a front surface of the cabinet and including a first hole to allow air to pass through the cooking chamber, a hood coupled to a lower portion of the main body, a fan disposed on one side of the main body to draw outside air into the main body, and a door arranged on a front side of the main body to open and close the cooking chamber, wherein the door including a second hole facing the first hole in response to the cooking chamber being closed by the door, and a through hole forming on an upper surface of the door.

### BRIEF DESCRIPTION OF THE DRAWINGS

FIG. 1 is a perspective view illustrating a state in which a cooking device according to an embodiment of the disclosure is installed.

FIG. 2 is a side view illustrating a state in which the cooking device according to an embodiment of the disclosure is installed.

FIG. 3 is a perspective view illustrating the cooking device according to an embodiment of the disclosure.

FIG. 4 is an exploded perspective view of the cooking device shown in FIG. 3.

FIG. 5 is a front view of the cooking device shown in FIG. 3.

FIG. 6 is a rear perspective view of the cooking device shown in FIG. 3 except for an outer case.

FIG. 7 is an enlarged view illustrating part “A” of FIG. 6.

FIG. 8 is a cross-sectional perspective view of the cooking device shown in FIG. 3 taken along line I-I′.

FIG. 9 is an enlarged view showing part “B” of FIG. 8.

FIGS. 10A to 100 are exemplary views illustrating an air discharge device of the cooking device shown in FIG. 8.

FIG. 11 is a view showing a main body of the cooking device shown in FIG. 3 except for a door.

FIG. 12 is a view illustrating an air discharge device of a cooking device according to another embodiment of the disclosure.

FIG. 13 is a perspective view illustrating a cooking device according to still another embodiment of the disclosure.

FIG. 14 is a cross-sectional perspective view of the cooking device of FIG. 13 taken along line II-II′.

### DETAILED DESCRIPTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function.

Furthermore, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

According to an embodiment of the disclosure, a cooking device is capable of preventing a cabinet from being discolored due to air discharged from the cooking device.

Moreover, according to an embodiment of the disclosure, a cooking device is capable of preventing foreign substances from penetrating into an air discharge device from the outside.

Further, according to an embodiment of the disclosure, air circulated inside the main body is discharged through an air discharge device provided on an upper side of a door (or control panel), and a gap between the main body and the door (or control panel), which prevents air from being discharged from a location closer to the cabinet and causing discoloration of the cabinet.

In addition, according to an embodiment of the disclosure, a cover portion partially covers the air discharge device, so that air circulating inside a cooking device may be discharged to the outside and foreign substances from the outside may be prevented from being introduced into the inside through the air discharge device.

Hereinafter, an embodiment of the disclosure will be described in detail with reference to the accompanying drawings.

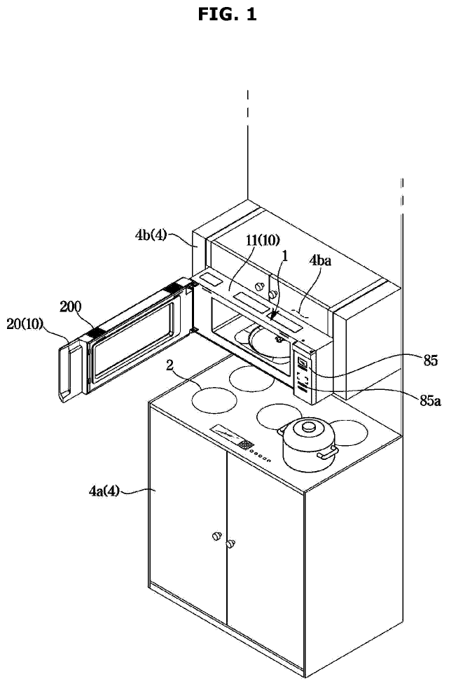

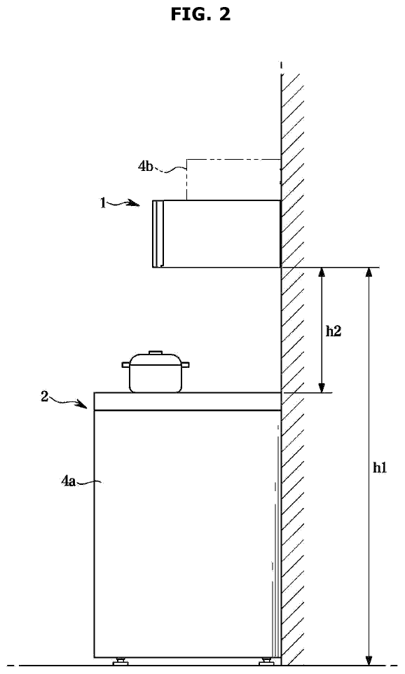

FIG. 1 is a perspective view illustrating a state in which a cooking device according to an embodiment of the disclosure is installed. FIG. 2 is a side view illustrating a state in which the cooking device according to an embodiment of the disclosure is installed.

Referring to FIGS. 1 and 2, a first cooking device 1 and a second cooking device 2 according to an embodiment of the disclosure may be disposed indoors. For example, the first and second cooking devices 1 and 2 may be disposed in a kitchen. The first cooking device 1 may be coupled to a cabinet 4. For example, the first cooking device 1 may be disposed in a storage space 4ba of an upper cabinet 4b.

The second cooking device 2 may be spaced apart from the first cooking device 1 by a predetermined distance h2 and may be installed below the first cooking device 1. For example, the second cooking device 2 may be disposed in a lower cabinet 4a.

The first cooking device 1 may be disposed above the second cooking device 2. The first cooking device 1 may discharge exhaust gas, smoke, or food smell generated by the second cooking device 2 to the outside. For example, the first cooking device 1 may function as a hood, but its function is not limited thereto. For example, the first cooking device may cook food with high frequency through a magnetron or cook food through a heater.

The first cooking device 1 may be installed at a predetermined height h1 from a floor. In this case, the first cooking device 1 may be installed at the appropriate height h1 according to the eye height of users or the height for easy manipulation of the first cooking device 1. For example, when the first cooking device 1 is a microwave oven, the first cooking device 1 may be an over-the-range (OTR) oven equipped with a hood 40.

Although an example in which the first and second cooking devices 1 and 2 are installed indoors has been described, a method of installing the first and second cooking devices 1 and 2 is not limited thereto. The first and second cooking devices 1 and 2 may be installed in various ways depending on the size or characteristics of a place to be installed and the purpose of the installation.

Hereinafter, the first cooking device 1 will be described in more detail. The first cooking device 1 is designated and described as a cooking device.

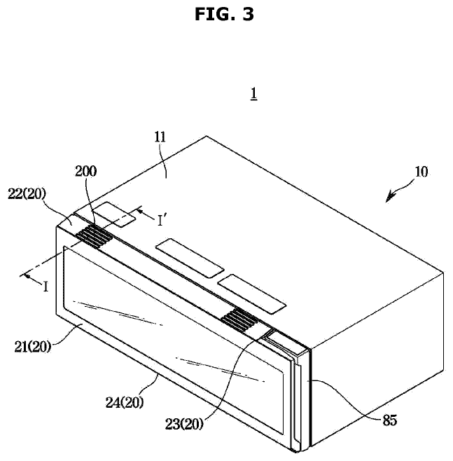

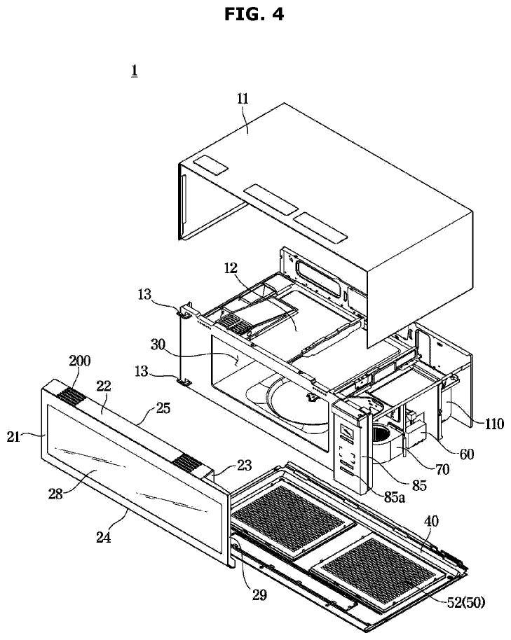

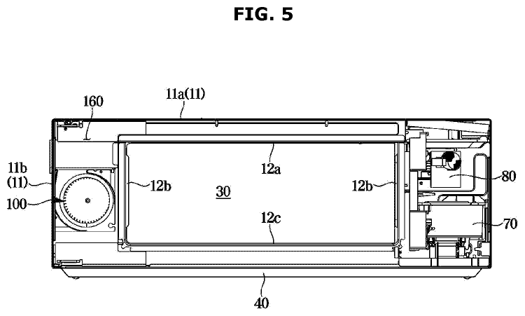

FIG. 3 is a perspective view illustrating the cooking device according to an embodiment of the disclosure. FIG. 4 is an exploded perspective view of the cooking device shown in FIG. 3.

Referring to FIGS. 3 and 4, the cooking device according to an embodiment of the disclosure may include a main body 10 and a door 20. As shown in FIGS. 1 and 2, the main body 10 may be accommodated in the storage space 4ba of the cabinet 4b so as to protrude from the cabinet 4b, but is not limited thereto. Alternatively, the main body 10 may be accommodated in the storage space 4ba of the cabinet 4b so as not to protrude from the cabinet 4b. The door 20 coupled to the main body 10 may be spaced apart from the cabinet 4b by a predetermined distance in a front direction of the cabinet 4b.

The main body 10 may include an outer case 11 and an inner case 12. The door 20 may include a front panel 21, an upper panel 22, a side panel 23, a lower panel 24, and a rear panel 25.

The door 20 may be provided in front of the main body 10. The door may be rotatably provided on the main body 10 to open and close the cooking chamber 30. For example, the door 20 may be coupled to the main body 10 by means of a hinge 13. However, a method of coupling the door 20 to the main body is not limited to the above example. The door 20 may have a shape corresponding to a front surface of the main body 10.

The door 20 may include a transmission portion 28 and a handle 29. The transmission portion 28 may allow the users to identify a cooking state of food in a cooking chamber 30. The handle 29 may be provided on an outer surface of the door 20 that the users may open and close the door 20.

The outer case 11 may be provided to accommodate the inner case 12 and electrical components. The outer case 11 may form an exterior of the main body 10. For example, the outer case 11 may cover the upper and left and right sides of the inner case 12 and electronic components. The outer case 11 may include an upper surface 11a and a side surface 11b.

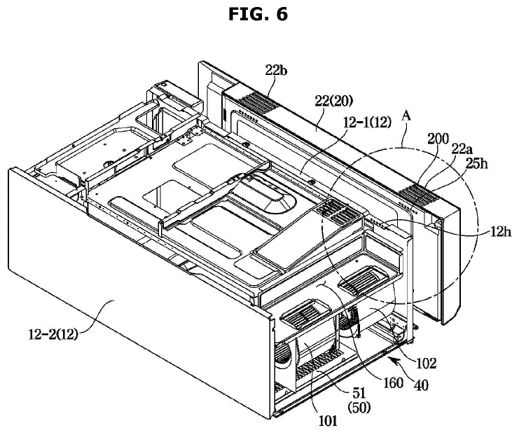

The cooking device may include an air discharge device 200, wherein the air discharge device 200 is provided to discharge air discharged from fans 101 and 102 (see FIG. 6) to the outside. The air discharge device 200 may be provided at an upper portion of the door 20. However, the location of the air discharge device 200 is not limited thereto and may be provided at any portion of the door 20.

The cooking device may further include the hood 40 and a filter 50. As shown in FIGS. 1 and 2, the hood 40 may be coupled to a lower portion of the main body 10 to intake smoke or air discharged from the second cooking device 2. For example, the hood 40 may cover the lower portion of the main body 10. The hood may include an inlet for drawing in smoke or air.

The filter 50 may be coupled to hood 40. The filter 50 may be placed at the inlet. The filter 50 may filter foreign substances included in the smoke discharged from the second cooking device 2. The filter 50 may include a first filter 51 and a second filter 52. For example, the first filter 51 may be placed adjacent to the fans 101 and 102, which will be described later. The second filter 52 may be spaced apart from the fans 101 and 102, which will be described later.

The cooking device 1 may further include the cooking chamber 30. The cooking chamber 30 may be provided in the inner case 12 to cook food.

The cooking device 1 may include a control panel 85 having manipulation buttons 85a capable of controlling a cooking operation of food. The cooking device 1 may further include a magnetron (not shown) for generating high frequencies and a heater (not shown) for generating heat. In addition, the cooking device 1 may further include a seating portion (not shown) disposed at lower portion of the cooking chamber 30 provided to seat food.

The cooking device 1 may include electrical components disposed within the outer case 11. The electrical components may include a controller 60 and a heat dissipation fan 70. The controller 60 and the heat dissipation fan 70 may be arranged on one side of the cooking chamber 30. For example, the controller 60 and the heat dissipation fan 70 may be disposed on the outside of the inner case 12. The controller 60 and the heat dissipation fan 70 may be disposed between the inner case 12 and the outer case 11. The controller 60 may control the intensity or strength of the magnetron and/or heater. The controller 60 may adjust the rotational speeds of the heat dissipation fan 70, the rear fan 111, and/or the fans 101 and 102. The heat dissipation fan 70 may dissipate heat generated from the controller 60 or a power board 80. Accordingly, the controller 60 or the power board 80 may prevent overheating, thereby improving a risk of failure.

FIG. 5 is a front view of the cooking device shown in FIG. 3.

Referring to FIG. 5, according to one embodiment of the disclosure, the inner case 12 may include a front plate 12-1 (see FIG. 6) and a rear plate 12-2 (see FIG. 6).

In addition, the inner case 12 may include an upper wall 12a, side walls 12b, and a lower wall 12c to form the cooking chamber 30 between the front plate 12-1 and the rear plate 12-2. The fans 101 and 102 may be disposed on one side of the inner case 12. For example, the fans 101 and 102 may be disposed on the right side of the inner case 12. The electrical components including the power board 80 may be disposed on the other side of the inner case 12. For example, the electrical components may be disposed on the left side of the inner case 12. The hood 40 and the lower wall 12c of the inner case 12 may be spaced apart from each other by a predetermined distance d, but are not limited thereto. The hood 40 and the lower wall 12c may be arranged adjacent to each other. For example, the hood 40 and the lower wall 12c may be in contact with each other.

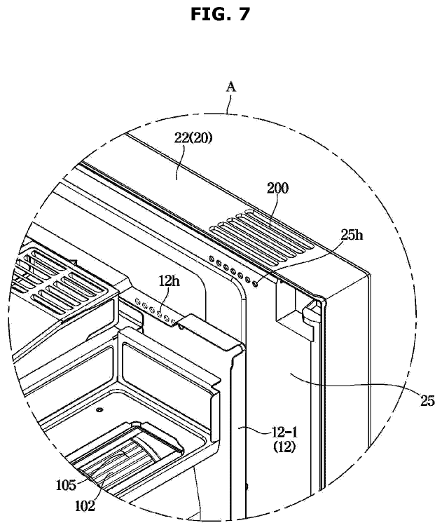

FIG. 6 is a rear perspective view of the cooking device shown in FIG. 3 excluding the outer case, and FIG. 7 is an enlarged view showing part “A” of FIG. 6.

Referring to FIG. 6, a discharge passage 160 may be provided within the outer case 11. The discharge passage 160 may be provided to allow air discharged from the outlet 105 of the fans to flow into a discharge duct. The discharge passage 160 may be provided between the inner case 12 and the outer case 11.

The air passing through the fans 101 and 102 may pass through the discharge passage 160 and be discharged to the outside through the air discharge device 200 provided at the upper portion of the door 20.

The fans 101 and 102 may be disposed between the inner case 12 and the outer case 11. The fans 101 and 102 may be disposed on one side of the inner case 12. For example, the fans 101 and 102 may be disposed on the right side of the inner case 12 to intake air from the filter 50.

The fans 101 and 102 may be provided in a plurality, and the plurality of fans 101 and 102 may include the first fan 101 and the second fan 102. However, the number of fans 101 and 102 is not limited to the above example and may be provided in one or three or more. A motor 103 may be connected to the fans 101 and 102 to drive the fans 101 and 102.

More specifically, referring to FIG. 7, the door 20 may communicate with the inner case 12 to enable air passing through the discharge passage 160 to be introduced into the door 20. The inside of the door 20 may communicate with the front plate 12-1 of the inner case 12.

In this case, first holes 12h through which air passes may be formed in the front plate 12-1 of the inner case 12, and second holes 25h corresponding to the first holes 12h may be formed in the rear panel 25 of the door 20. Each of the first holes 12h and the second holes 25h may be provided with one or more to correspond to each other, and the number thereof is not limited.

Air may be moved to the inside of the door 20 through the first holes 12h and the second holes 25h in sequence, and the air that has been moved to the inside of the door 20 may be discharged to the outside through the air discharge device 200 provided in the upper portion of the door 20, that is, the upper panel 22. In this case, as shown in FIG. 6, the air discharge devices 200 may be provided on a first side 22a and a second side 22b of the upper panel 22 of the door 20, respectively, but is not limited thereto. The air discharge devices 200 may be provided on one or more sides of the upper panel 22 of the door 20. When the air discharge devices 200 are provided on the first side 22a and the second side 22b of the upper panel 22 of the door 20, the first holes 12h described above may be provide on one side and the other side of the front plate 12-1 of the inner case 12 to correspond the air discharge device 200, and the second holes 25h may be provided on one side and the other side of the rear panel 25 of the door 20 to correspond to the air discharge device 200. However, in the following, only the air discharge device 200 provided on the first side 22a will be described.

Furthermore, the air discharge devices 200 may be provided on the front panel 21, the side panel 23, or the lower panel 24, in addition to the upper panel 22 of the door 20. The air discharge devices 200 may be provided adjacent to the fans 101 and 102 and the discharge passage 160 to enable air to be effectively discharged.

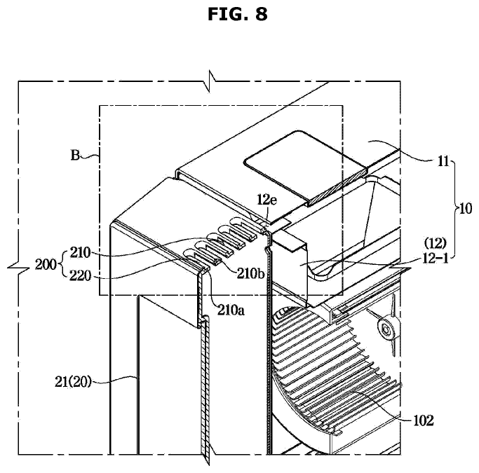

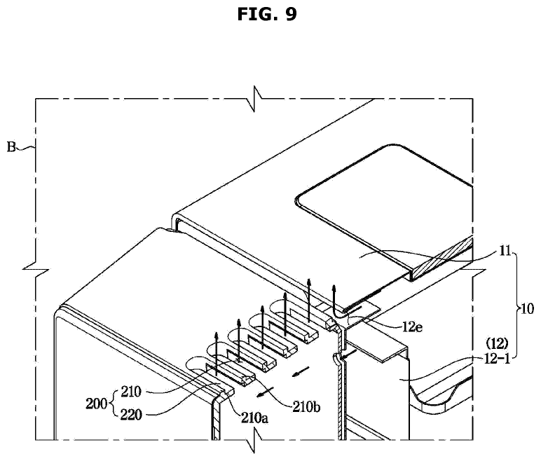

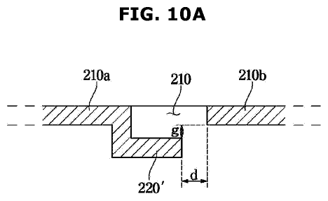

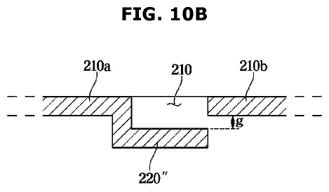

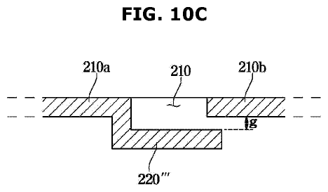

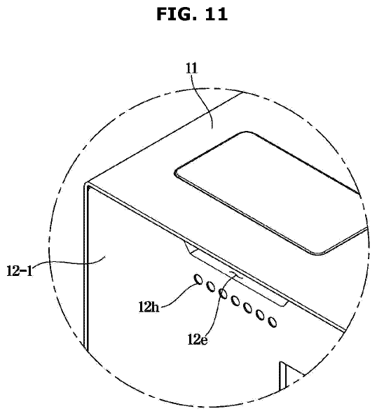

FIG. 8 is a cross-sectional perspective view of the cooking device shown in FIG. 3 taken along line I-I′, FIG. 9 is an enlarged view showing part “B” of FIG. 8, FIGS. 10A to 100 are exemplary views illustrating the air discharge device of the cooking device shown in FIG. 8, and FIG. 11 is a view illustrating the main body of the cooking device shown in FIG. 3 except for the door.

Referring to FIGS. 8 and 9, air, as indicated by arrows, may pass sequentially through the first holes and the second holes through the discharge passage and then be discharged through the air discharge device 200 provided on the upper panel 22 of the door 20.

The air discharge device 200 may include a plurality of through holes 210, and the plurality of through holes 210 may be disposed along the front direction of the door 20. As shown in FIG. 1, the door 20 may protrude from the cabinet 4b. Accordingly, when air is discharged through the air discharge device provided on the upper panel of the door 20, the air does not come into contact with the cabinet 4b, so that discoloration of the cabinet due to air may be prevented.

More specifically, the air discharge device 200 may further include a cover portion 220 provided to partially cover the through holes.

The plurality of through holes 210 may be provided in a shape penetrating the upper panel 22 to enable the air introduced into the door 20 to be discharged to the outside. As shown in the drawings, the plurality of through holes 210 may be provided in a circular shape, but is not limited thereto. The plurality of through holes may be provided in various shapes, such as a triangle and a rectangle, and may be formed in various other shapes.

The cover portion 220 may prevent foreign substances from entering the inside of the door 20 through the through holes. To this end, the cover portion 220 may extend from a first section 210a around the through holes 210 to cover a portion of the through holes 210. At the same time, the cover portion 220 may be spaced apart from a second section 210b around the through holes 210 to form a gap g (see FIG. 10A), so that air may be discharged to the outside.

In this case, the second section 210b may be positioned closer to the main body 10 than the first section 210a. Accordingly, the air that has passed through the main body 10 may be easily discharged through the gap provided adjacent to the second section 210b.

Meanwhile, referring to FIG. 10A, an end of a cover portion 220′ may be spaced apart from the second section 210b by a predetermined distance d in a horizontal direction.

In contrast, referring to FIG. 10B, an end of a cover portion 220″ may be disposed in a straight line along a vertical direction without being spaced apart from the second section 210b in the horizontal direction.

Alternatively, referring to FIG. 100, an end of a cover portion 220′″ may extend in a direction toward the main body closer to the main body than the second section 210b.

Referring to FIGS. 9 and 11, the front plate 12-1 of the inner case 12 may be provided with an opening 12e that opens toward a front side of the inner case 12. The opening 12e may be provided in a shape passing through the front plate 12-1. As the outer case 11 covers an upper portion of the inner case 12, the opening 12e between the outer case 11 and the inner case 12 may form a discharge channel through which air passes.

When the door 20 closes the cooking chamber, the rear panel 25 of the door 20 may be positioned to face the front plate 12-1 of the inner case 12. Accordingly, when the door 20 closes the cooking chamber 30, the air passing through the opening 12e may be discharged through a gap between the rear panel 25 of the door 20 and the front panel 12-1 of the inner case 12.

Conventionally, an outlet is provided in the outer case to allow air to be discharged to the outside through the outlet, while in the cooking device 1 according to the disclosure, air may be discharged through the gap between the main body 10 and the door 20. Accordingly, air may be discharged at a location relatively far from the cabinet, so that discoloration of the cabinet due to air may be prevented.

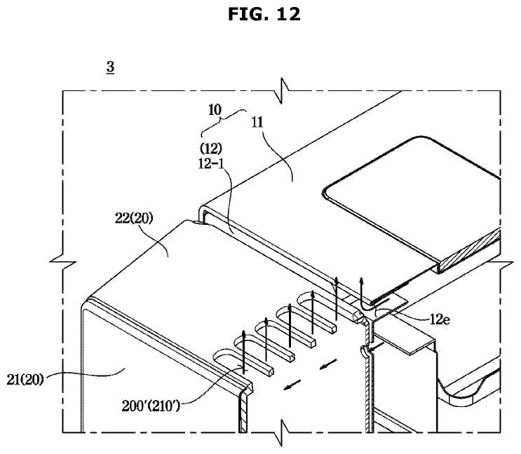

FIG. 12 is a view illustrating an air discharge device of a cooking device according to another embodiment of the disclosure.

A cooking device 3 according to the disclosure is substantially the same as the cooking device 1 described with reference to FIGS. 1 to 11 except for an air discharge device, and therefore the same reference numerals will be used and duplicate descriptions will be omitted.

Referring to FIG. 12, an air discharge device 200′ provided on the upper panel 22 of the door 20 of the cooking device 3 may include a plurality of through holes 210′. The plurality of through holes 210′ may be arranged along the front direction of the door 20. In this case, the air introduced into the door 20 may be discharged through the relatively wide through holes 210′, thereby discharged to the outside more efficiently.

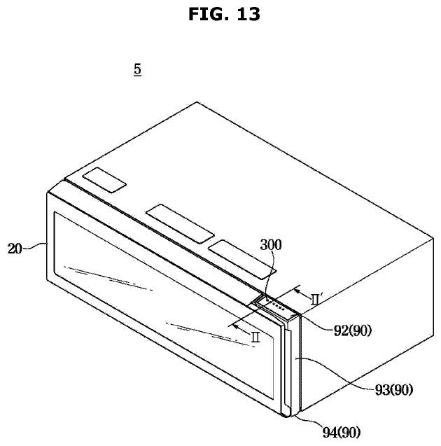

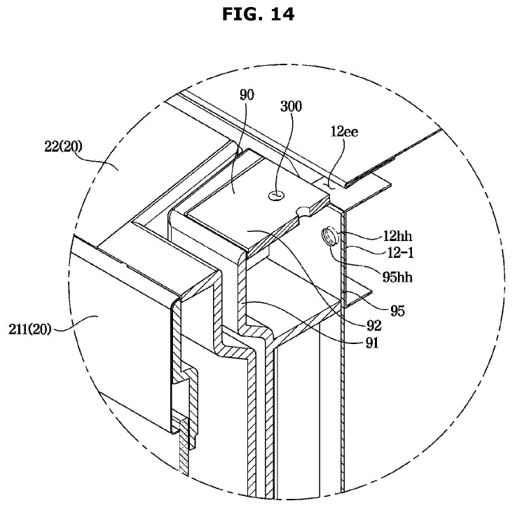

FIG. 13 is a perspective view illustrating a cooking device according to still another embodiment of the disclosure, and FIG. 14 is a cross-sectional perspective view of the cooking device of FIG. 13 taken along line II-II′.

A cooking device 5 according to the disclosure is substantially similar to the cooking device 1 described with reference to FIGS. 1 to 11 or the cooking device 3 described with reference to FIG. 12 except that an air discharge device is provided on the control panel, and therefore the same reference numerals will be used and duplicate descriptions will be omitted.

Referring to FIGS. 13 and 14, in the cooking device 5, the door 20 is provided on one side of the front of the main body 10, and a control panel 90 having one or more manipulation buttons for controlling a cooking operation of food is provided on the other side of the front of the main body 10. The door 20 may extend from one side of the front of the main body 10 to cover the control panel 90, but is not limited thereto. The door 20 may be positioned side by side with the control panel 90.

The air drawn into the main body 10 by the fans 101 and 102 may be moved to one side adjacent to the control panel 90 through an internal flow path (not shown) and then be discharged to the outside through an air discharge device 300 provided in the control panel 90.

The control panel 90 may include a front surface panel 91, an upper surface panel 92, a side surface panel 93, a lower surface panel 94, and a rear surface panel 95.

The air discharge device 300 may be provided on the upper surface panel 92 of the control panel 90. However, the air discharge device 300 may be provided on the side surface panel 93 or the lower surface panel 94 of the control panel 90 and may be provided in various positions of the control panel.

A plurality of first holes 12hh may be provided in the front plate 12-1 of the main body 10 to allow air to pass through, and a plurality of second holes 95hh may be provided in the rear surface panel 95 of the control panel 90 to communicate with the plurality of first holes 12hh of the front plate 12-1. The air moving from the inside of the main body 10 to the control panel 90 may flow into the control panel 90 through the first holes 12hh and the second holes 95hh in sequence.

The air moved to the inside of the control panel 90 may be discharged to the outside through the air discharge device 300 provided on the upper surface panel 92 of the control panel 90. The air discharge device 300 may be provided in a shape penetrating the upper surface panel 92, but is not limited thereto. The air discharge device 300 may have the same structure, shape and characteristic as the air discharge device 200 described with reference to FIGS. 8 and 9 or the air discharge device 200′ described with reference to FIG. 10.

Furthermore, an opening 12ee may be provided in the front plate 12-1 of the inner case 12 of the main body 10 to allow air to pass therethrough. The opening 12ee may be provided to open at the front panel 12-1 toward the rear surface panel 95 of the control panel 90. As the outer case 11 covers the upper portion of the inner case 12, the opening 12ee between the outer case 11 and the inner case 12 may form a discharge channel through which air passes.

The rear surface panel 95 of the control panel 90 may be placed to face the front plate 12-1 of the inner case 12. Accordingly, the air passing through the opening 12ee may be discharged through a gap between the rear surface panel 95 of the control panel 90 and the front plate 12-1 of the inner case 12.

Conventionally, an outlet is provided in the outer case to allow air to be discharged to the outside through the outlet, while in the cooking device 5 according to the disclosure, air may be discharged through the gap between the main body 10 and the control panel 90. Accordingly, air may be discharged at a location relatively far from the cabinet, so that discoloration of the cabinet due to air may be prevented.

As described above, the air discharge devices 200, 200′, and 300 of the cooking devices 1, 3, and 5 according to the disclosure may serve to discharge filtered air drawn into the main body 10 from the outside. Furthermore, when the air discharge devices 200, 200′, 300 may serve to draw in air from the outside when the fans 101 and 102 provided within the main body 10 are rotated reversely, that is, rotated in the opposite direction from when air is drawn in through the inlet. At this time, the air is drawn into the inside of the main body 10 through the air discharge devices 200, 200′, and 300, filtered, and then discharged through the inlet or an opening provided on the outer surface of the main body 10 (not shown).

While the present disclosure has been particularly described with reference to exemplary embodiments, it should be understood by those of skilled in the art that various changes in form and details may be made without departing from the spirit and scope of the present disclosure.

What is claimed is:

1. A cooking device comprising:
a main body forming a cooking chamber, the main body including a front plate having at least one first hole;
a hood coupled to a lower portion of the main body;
a fan; and
a door to open and close the cooking chamber, and including a rear panel having at least one second hole,
wherein the main body, the hood, the fan, and the door are configured so that, with the cooking chamber being closed by the door, the fan is operable to draw in air through the hood, and the air drawn in by the fan passes through the at least one first hole and then through the at least one second hole to an inside of the door.

2. The cooking device of claim 1, wherein
the at least one first hole includes a plurality of first holes, and
the at least one second hole includes a plurality of second holes.

3. The cooking device of claim 1, wherein the door further includes an upper panel provided with at least one air discharge device including a through hole to discharge the air in the inside of the door to an outside of the cooking device.

4. The cooking device of claim 3, wherein
the air discharge device further includes a cover portion covering a portion of the through hole, and
the cover portion includes a gap between the cover portion and the upper panel to allow the air in the inside the door to be discharged to the outside of the cooking device through the through hole.

5. The cooking device of claim 4, wherein the cover portion is configured to extend from a first section around the through hole, and to form the gap between the cover portion and a second section around the through hole.

6. The cooking device of claim 5, wherein the second section is closer to the main body than the first section.

7. The cooking device of claim 3, wherein
the at least one air discharge device includes a plurality of air discharge devices, and
the plurality of air discharge devices is arranged along a front direction of the door.

8. The cooking device of claim 3, wherein
the main body is positionable in a storage space of a cabinet, and,
when the main body is positioned in the storage space of the cabinet, the door protrudes forward from the cabinet.

9. The cooking device of claim 1, wherein
the main body further includes:
an outer case, and
an inner case accommodated in the outer case and forming the cooking chamber; and
the inner case includes the front plate.

10. The cooking device of claim 9, wherein an opening is in the front plate to, with the cooking chamber being closed by the door, allow air inside the main body to be discharged between the rear panel of the door and the front plate.

11. The cooking device of claim 10, wherein the opening is provided on a side adjacent to the fan.

12. A cooking device comprising:
a main body forming a cooking chamber;
a hood coupled to a lower portion of the main body;
a fan;
a door configured to open and close the cooking chamber; and
a control panel including a manipulation button and mounted on a front surface of the main body so that an inside of the control panel communicates with an inside of the main body,
wherein the main body, the hood, the fan, the door, and the control panel are configured to that, with the cooking chamber being closed by the door, the fan is operable to draw in air through the hood, and the air drawn in by the fan is introduced into the inside of the main body and thereafter to the inside of the control panel and is then discharged to outside of the cooking device through an upper portion of the control panel.

13. The cooking device of claim 12, wherein
the main body further includes a front plate having a first hole, and
the control panel further includes a rear surface panel having a second hole,
wherein the first hole and the second hole are configured so that the air introduced into the inside of the main body passes through the first hole and then through the second hole to be introduced to the inside of the control panel.

14. The cooking device of claim 13, wherein the control panel further includes an upper surface panel having an air discharge device including a through hole to discharge the air introduced to the inside the control panel to the outside of the cooking device.

15. The cooking device of claim 14, wherein an opening is provided in the front plate to, with the cooking chamber being closed by the door, allow the air inside the control panel to be discharged between the rear surface panel of the control panel and the front plate.
